(19) United States
(12) Patent Application Publication
(10) Pub. No.: US 2007/0235999 A1
(43) Pub. Date: Oct. 11, 2007

(54) Vehicle seat belt apparatus

(76) Inventors: Mark A. Morra, Clarkston, MI (US); Mark O. Ellis, Rochester Hills, MI (US); Derek Y. Guo, Troy, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 11/398,953

(22) Filed: Apr. 6, 2006

(51) Int. Cl. B60R 21/00; B60R 22/46

(52) U.S. Cl. 280/806; 180/268; 297/483

(57) ABSTRACT

The apparatus of the present invention provides a seat belt apparatus configured to restrain an occupant seated in a vehicle car seat having a seat back portion and a seat base portion. The seat belt apparatus includes a lap belt defining an inboard portion and an outboard portion. The seat belt apparatus also includes a tether defining a first end portion and a second end portion. The second end portion of the tether is secured to the outboard portion of the lap belt. A pre-tensioner is positioned below, rearward and inboard of the occupant's outboard hip. The pre-tensioner is selectively configured to retract the tether thereby applying force to the occupant in a downward and inboard direction.

### TECHNICAL FIELD

The present invention pertains generally to an improved seat belt apparatus.

### BACKGROUND OF THE INVENTION

It is well known in motor vehicles to restrain a seated occupant with a seat belt apparatus such as a conventional three-point seat belt. The three-point seat belt typically includes a lap belt and a shoulder belt which reach around and thereby secure an occupant to the car seat. The seat belt apparatus may also include a seat belt tensioning device or pre-tensioner which forcibly tensions the seat belt in response to a vehicle condition such as vehicle deceleration or an impact.

### SUMMARY OF THE INVENTION

The seat belt apparatus of the present invention is configured to restrain an occupant seated in a vehicle car seat having a seat back portion and a seat base portion. The seat belt apparatus includes a lap belt defining an inboard portion and an outboard portion. The seat belt apparatus also includes a tether defining a first end portion and a second end portion. The second end portion of the tether is secured to the outboard portion of the lap belt. A pre-tensioner is positioned below, rearward and inboard of the occupant's outboard hip. The pre-tensioner is selectively configured to retract the tether thereby applying force to the occupant in a downward and inboard direction.

The seat belt apparatus may include an electronic device configured to transmit a signal to actuate the pre-tensioner.

The second end portion of the tether may be secured to the outboard portion of the lap belt with stitching.

The second end portion of the tether may define a loop through which the outboard portion of the lap belt is passed in order to secure the tether to the lap belt.

The seat belt apparatus may include a pulley configured to engage the tether in order to re-direct the line of force applied by the pre-tensioner.

The pre-tensioner may include a pyrotechnic charge.

The pre-tensioner may include a re-settable mechanical storage device.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic front view illustration of a safety belt apparatus applied to an occupant seated in a car seat;

FIG. 2 is a schematic side view illustration of the safety belt apparatus of FIG. 1 applied to an occupant seated in a car seat;

FIG. 3 is a schematic front view illustration of a safety belt apparatus in accordance with an alternate embodiment of the present invention; and

FIG. 4 is a schematic front view illustration of a safety belt apparatus in accordance with another alternate embodiment of the present invention.

### DESCRIPTION OF THE PREFERRED EMBODIMENTS

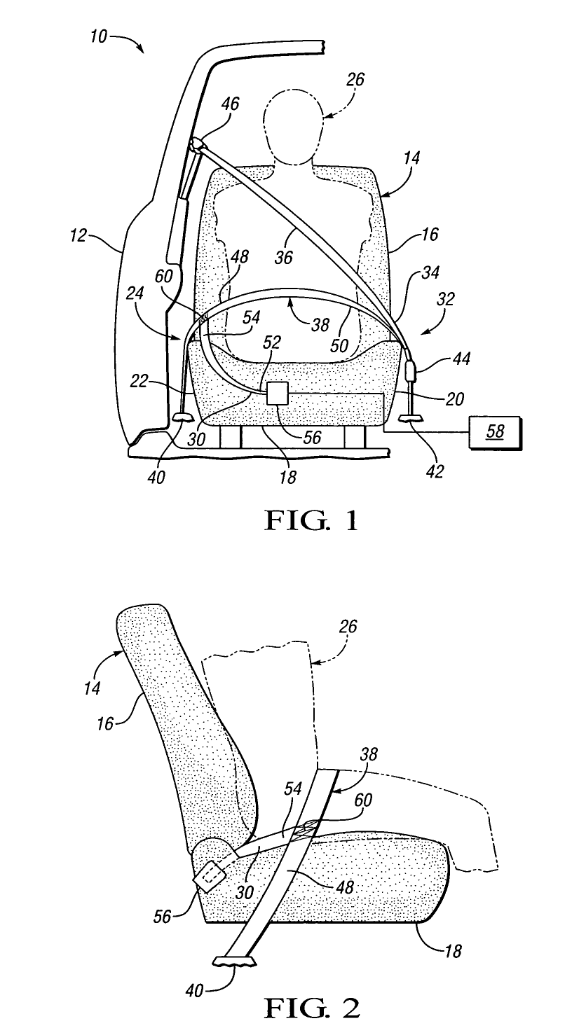

Referring to the drawings, wherein like reference numbers refer to like components, FIG. 1 shows a passenger side door panel 12 of a vehicle 10. A seat 14 including a back portion 16 and a base portion 18 is disposed within the vehicle 10. The base portion 18 of the seat 14 includes an inboard side 20 and an outboard side 22. A seat belt assembly 24 is applied to an occupant 26 seated in the seat 14. The seat belt assembly 24 includes a seat belt tether 30 in accordance with the present invention that is attached to a three-point seat belt apparatus 32. The tether 30 is preferably composed of a conventional seat belt type construction; however, alternate compositions such as a cable or a cord may also be envisioned.

Alternatively, the tether 30 may include two connectable portions (not shown) to facilitate assembly. The first connectable portion of the tether 30 would preferably be installed into a vehicle as part of the three-point seat belt apparatus 32, and the second connectable portion of the tether 30 would be pre-assembled to the base portion 18 of the seat 14. Therefore, after separately installing the seat 14 and the three-point seat belt apparatus 32 into a vehicle, the first and second connectable portions of the tether 30 can be connected together to simplify the installation of the seat belt assembly 24. The alternative tether 30 composition including two connectable portions also allows for the use of two different materials such as, for example, a seat belt material for the portion of the tether 30 that engages the occupant and a metallic strap or cable for the portion of the tether 30 that is operatively connected to the pre-tensioner 56.

The three-point seat belt apparatus 32 includes a single belt 34 defining a shoulder belt portion 36 and a lap belt portion 38. When the three-point seat belt apparatus 32 is in its applied position shown in FIG. 1, the lap belt portion 38 is defined between an outboard anchor 40 and an inboard anchor 42 to which the belt is attached with a buckle device 44. Similarly, when the three-point seat belt apparatus 32 is in its applied position shown in FIG. 1, the shoulder belt portion 36 is defined between an outboard anchor 46 and the inboard anchor 44. The lap belt portion 38 further defines an outboard portion 48 and an inboard portion 50. The three-point seat belt apparatus 32 is shown for illustrative purposes, however, it should be appreciated that the present invention may also be applied to alternate seat belt configurations.

The seat belt tether 30 includes a first end portion 52 and a second end portion 54 opposite the first end portion 52. The first end portion 52 of the seat belt tether 30 is operatively connected to a belt tensioning device or pre-tensioner 56. The pre-tensioner 56 is selectively configured to rapidly retract at least a portion of the tether 30. The pre-tensioner 56 typically retracts the tether in response to a signal generated by existing electrical hardware 58 which may otherwise be implemented to deploy side airbags and/or roof rail airbags (not shown) during side impact or rollover events.

According to the preferred embodiment, the pre-tensioner 56 includes a pyrotechnic charge device (not shown) that may be ignited to retract the tether 30 in the event of an accident. According to an alternate embodiment, the pre-tensioner 56 includes a mechanical energy storage device (not shown) such as a spring which may be actuated to retract the tether 30 in the event of an accident. Advantageously, the mechanical energy storage device is re-settable such that servicing the device after actuation is less expensive than with a pyrotechnic device which is typically deployable only once.

As shown in FIGS. 1 and 2, the pre-tensioner 56 is disposed within the base portion 18 of the seat 14 and is positioned approximately in the middle but somewhat nearer to the outboard side 22 than the inboard side 20. With respect to the occupant 26 seated in the seat 14, the pre-tensioner 56 is positioned below, rearward and inboard of the occupant's outboard hip. It has been observed that positioning the pre-tensioner 56 as shown in FIGS. 1 and 2 optimally directs the line of force applied by the tether 30 to the occupant 26 as will be described in detail hereinafter.

Alternatively, the pre-tensioner 56 may be positioned nearer the inboard side 20 of the base portion 18 (similar to the positioning of the pre-tensioner 70 shown in FIG. 4). This alternative positioning of the pre-tensioner 56 may be required for packaging purposes as some car seats may have limited available space in the area in which the pre-tensioner 56 of FIGS. 1 and 2 is shown. In order to optimally direct the line of force applied by the alternatively positioned pre-tensioner 56, a pulley (similar to the pulley 72 shown in FIG. 4) is positioned in generally the same location as the pre-tensioner 56 of FIG. 1. Accordingly, the pulley engages the tether 30 to more optimally direct the line of force applied to the occupant 26 by the alternatively positioned pre-tensioner 56.

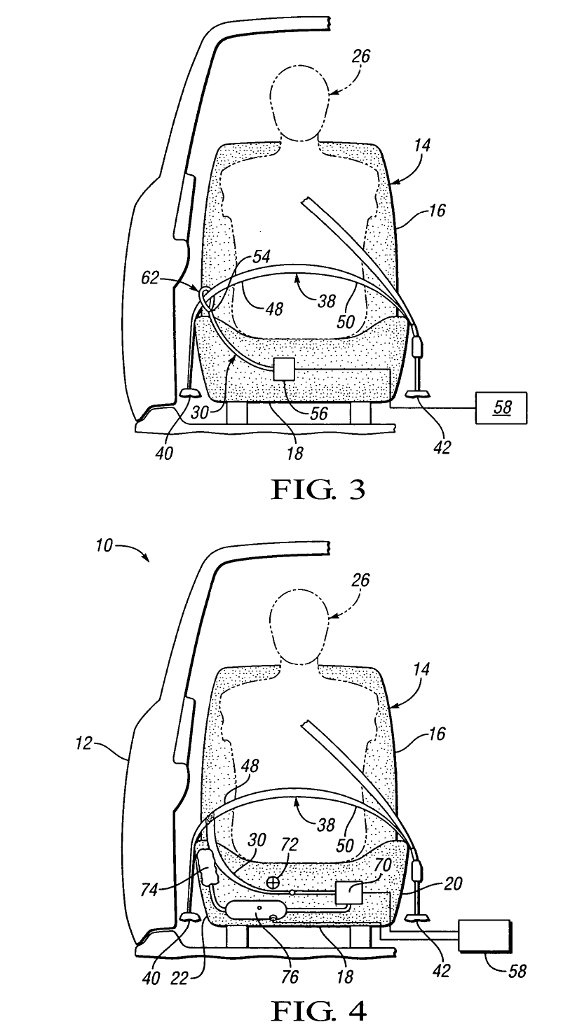

The second end portion 54 of the seat belt tether 30 engages the outboard portion 48 of the lap belt 38. According to the preferred embodiment shown in FIGS. 1 and 2, the second end portion 54 of the seat belt tether 30 is affixed to the outboard portion 48 of the lap belt 38 such as, for example, with stitching 60. According to an alternate embodiment shown in FIG. 3, the second end portion 54 of the seat belt tether 30 may be slideably attached to the outboard portion 48 of the lap belt 38 such as, for example, by forming a loop 62 at the second end portion 54 of the seat belt tether 40 through which the lap belt 38 is passed. Advantageously, the loop 62 allows relative motion between the tether 30 and the lap belt 38 which may more evenly distribute an applied load between the tether 30 and the lap belt 38. If the tether 30 is sufficiently stiff (e.g., a cable type design), the loop 62 may also function as a lap belt positioning apparatus or a guide loop for optimal lap belt 38 routing across an occupant's pelvis.

According to another alternate embodiment of the present invention, a car seat (not shown) having an integral torso airbag module (not shown) may be modified to transmit an airbag deployment signal to actuate the pre-tensioner 56. In other words, instead of implementing the existing electrical hardware 58 to actuate the pre-tensioner 56, the pre-tensioner could be actuated by an electrical or pneumatic signal from the airbag module such that the integral torso airbag (not shown) is deployed and generally simultaneously the tether 30 is also retracted.

Having described the structure in accordance with the preferred embodiment of the present invention, its operation will now be explained. Referring again to FIG. 1, it can be seen that the actuation of the pre-tensioner 56 retracts the tether 30 and thereby applies two primary load components to the occupant 26. The first load component is applied in a downward direction toward the seat base 18, and the second load component is applied in an inboard direction.

Referring to FIG. 4, another alternate embodiment of the present invention is shown. A pre-tensioner 70 is positioned within the base portion 18 of the seat 14 near the inboard side 20. It should be appreciated that the pre-tensioner 70 is relocated from the preferred position shown in FIG. 1 to accommodate additional structure within the base portion 18 which will be described in detail hereinafter. Therefore, if a particular base portion allows for such a design, the pre-tensioner 70 would preferably be positioned similarly to the pre-tensioner 56 shown in FIG. 1, and the pulley 72 of FIG. 4 would not be necessary.

The tether 30 is operatively connected to the pre-tensioner 70 and is also engaged with the outboard portion 48 of the lap belt 38. The tether 30 is shown stitched to the lap belt 38; however, other forms of engagement such as, for example, the slidable loop 62 of FIG. 3 may also be envisioned. In order to optimally direct the line of force applied by the tether 30 to the occupant 26, the pulley 72 is positioned in generally the same location as the pre-tensioner 56 of FIG. 1. The pulley 72 acts to redirect the force applied by the pre-tensioner 70 such that the generally horizontally applied force depicted in FIG. 4 is translated into first and second load components applying force to the occupant 26 in a downward direction and an inboard direction, respectively.

A pelvic airbag 74 is disposed within the base portion 18 of the seat 14 in close proximity to the outboard side 22. The pelvic airbag 74 is operatively connected to an energy producing device 76 which is also operatively connected to the pre-tensioner 70. The energy producing device 76 is selectively configured to both actuate the pre-tensioner 70 and deploy the pelvic airbag 74. Therefore, during an event such as an impact to the side door panel 12, the pre-tensioner 70 retracts the tether 30 to apply a force to the occupant in a downward and inboard direction, and the pelvic airbag 74 is inflated to protect the occupant's pelvic region.

According to the preferred embodiment shown in FIG. 4, the pre-tensioner 70, the pulley 72, the energy producing device 76, the pelvic airbag 74, and at least a portion of the tether 30 are all disposed within the base portion 18 of the seat 14 which may be shipped as a single pre-assembled component in order to simplify final vehicle assembly.

While the best modes for carrying out the invention have been described in detail, those familiar with the art to which this invention relates will recognize various alternative designs and embodiments for practicing the invention within the scope of the appended claims.

1. A seat belt apparatus comprising:
a lap belt defining an inboard portion and an outboard portion;
a tether defining a first end portion and a second end portion, the second end portion of the tether being secured to the outboard portion of the lap belt; and
a pre-tensioner operatively connected to the first end portion of the tether, said pre-tensioner selectively configured to retract the tether thereby applying force to the occupant in a downward and inboard direction.

2. The seat belt apparatus of claim 1, further comprising an electronic device operatively connected to the pre-tensioner, said electronic device configured to transmit a signal to actuate the pre-tensioner.

3. The seat belt apparatus of claim 1, wherein the second end portion of the tether is secured to the outboard portion of the lap belt with stitching.

4. The seat belt apparatus of claim 1, wherein the second end portion of the tether defines a loop through which the outboard portion of the lap belt is passed in order to secure the tether to the lap belt.

5. The seat belt apparatus of claim 1, further comprising a pulley disposed within the seat base portion, said pulley configured to engage the tether in order to re-direct the line of force applied by the pre-tensioner.

6. The seat belt apparatus of claim 1, wherein the pre-tensioner includes a pyrotechnic charge.

7. The seat belt apparatus of claim 1, wherein the pre-tensioner includes a re-settable mechanical storage device.

8. The seat belt apparatus of claim 1, wherein the pre-tensioner is positioned below, rearward and inboard relative to an occupant's outboard hip.

9. The seat belt apparatus of claim 1, wherein the tether includes two connectable portions.

10. A seat belt apparatus configured to restrain an occupant seated in a vehicle car seat including a seat back portion and a seat base portion, said seat belt apparatus comprising:
a lap belt defining an inboard portion and an outboard portion;
a tether at least partially disposed within the seat base portion, said tether defining a first end portion and a second end portion opposite said first end portion, the second end portion of the tether being secured to the outboard portion of the lap belt;
a pre-tensioner disposed within the seat base portion, said pre-tensioner operatively connected to the first end portion of the tether, said pre-tensioner selectively configured to retract the tether thereby applying force to the occupant in a downward and inboard direction; and
an electronic device operatively connected to the pre-tensioner, said electronic device configured to transmit a signal to actuate the pre-tensioner.

11. The seat belt apparatus of claim 10, wherein the second end portion of the tether is secured to the outboard portion of the lap belt with stitching.

12. The seat belt apparatus of claim 10, wherein the second end portion of the tether defines a loop through which the outboard portion of the lap belt is passed in order to secure the tether to the lap belt.

13. The seat belt apparatus of claim 10, further comprising a pulley disposed within the seat base portion, said pulley configured to engage the tether in order to re-direct the line of force applied by the pre-tensioner.

14. The seat belt apparatus of claim 13, wherein the pre-tensioner includes a pyrotechnic charge.

15. The seat belt apparatus of claim 13, wherein the pre-tensioner includes a re-settable mechanical storage device.

16. A safety device for an occupant seated in a car seat that includes a seat back portion and a seat base portion, said safety device comprising:
a lap belt defining an inboard portion and an outboard portion;
a tether defining a first end portion and a second end portion opposite said first end portion, the second end portion of the tether being secured to the outboard portion of the lap belt;
a pre-tensioner operatively connected to the first end portion of the tether, said pre-tensioner configured to retract the tether thereby applying force to the occupant in a downward and inboard direction;
a pelvic airbag disposed within the seat base portion, said pelvic airbag being inflatable to protect the occupant's pelvic region; and
an energy producing device operatively connected to said pre-tensioner and said pelvic airbag, said energy producing device being configured to selectively actuate the pre-tensioner and the pelvic airbag.

17. The safety device of claim 16, wherein the second end portion of the tether is secured to the outboard portion of the lap belt with stitching.

18. The safety device of claim 16, wherein the second end portion of the tether defines a loop through which the outboard portion of the lap belt is passed in order to secure the tether to the lap belt.

19. The safety device of claim 16, further comprising a pulley disposed within the seat base portion, said pulley configured to engage the tether in order to re-direct the line of force applied by the pre-tensioner.

20. The safety device of claim 16, wherein the pre-tensioner is positioned below, rearward and inboard relative to an occupant's outboard hip.
